(19) United States
(12) Patent Application Publication
(10) Pub. No.: US 2004/0241599 A1
(43) Pub. Date: Dec. 2, 2004

(54) Quiescent development of lithographic plates

(76) Inventors: Howard A. Fromson, Stonington, CT (US); William J. Rozell, Vernon, CT (US)

Correspondence Address: ALIX YALE & RISTAS LLP, 750 MAIN STREET, SUITE 1400, HARTFORD, CT, 06103, US

(21) Appl. No.: 10/826,535

(22) Filed: Apr. 16, 2004

Related U.S. Application Data
(63) Continuation-in-part of application No. 10/446,357, filed on May 28, 2003, now Pat. No. 6,793,418.

(51) Int. Cl. G03C 5/18; B41J 2/01

(52) U.S. Cl. 430/434; 347/103

(57) ABSTRACT

The invention is directed to the development of lithographic printing plates and comprises the application of a thin, quiescent film of developer solution to each plate in a controlled manner using, for example, a wire-wound coating device or an ink-jet type head. A feature of this quiescence is that the developer fluid is applied uniformly with self-leveling over the plate at the required thickness. In the preferred embodiment the fluid is gently fed onto the wire-wound device by simple volumetric displacement and overflow from the inside of a hollow tube onto the wire, and the flow is controlled by sensing the beginning and end of each plate. The developer dwells on the plate as it is conveyed across a stable horizontal support structure for a sufficient time to allow for undisturbed vertical percolation into and/or dissolution of the soluble regions of the coating, without being subjected to lateral forces that would promote seepage of developer into the base of adjacent areas where dissolution is not desired.

### RELATED APPLICATIONS

This application is a continuation-in-part of U.S. application Ser. No. 10/446,357 filed May 28, 2003 and claims the benefit under 35 U.S.C. Sec. 120 of the filing dates of U.S. application Ser. No. 10/783,759 filed Feb. 20, 2004, which is a continuation-in-part U.S. application Ser. No. 10/446,582 filed May 28, 2003.

### BACKGROUND OF THE INVENTION

The present invention is directed to a method for developing positive working lithographic plates, particularly lithographic printing plates that have been imaged and require the application of a developer to remove the areas of the coating on the plate which have been rendered soluble by the imaging exposure.

The most common technique for developing imaged lithographic plates is to immerse plates in sequence through a bath or sump, where the developer is continuously circulated and replenished.

Another known method for the development of the imaged plates entails forming a thin film or layer of developing solution on the imaged plate surface of each imaged plate to be developed. This thin film of developer solution is allowed to dwell on the plate for a time sufficient to complete the development and then is rinsed from the plate. Because only a thin film of developer solution is formed on each plate, any variation of any part of the surface of the plate from substantially flat and horizontal, any variation in the thickness of the film of developer, and any variation in the dwell time of the developer on different areas of the plate can result in the improper development of the coating.

The use of a wire-wound rod as a coating means is well suited to the continuous coating of web materials with a fluid, and well known in the art. Typically, a wire-wound coating rod is used in a coating method where some volume of fluid is continuously applied to the web surface upstream of the rod, and the rod serves to meter the amount of fluid allowed to remain on the web surface. However, the coating of individual, discrete plates requires the ability to precisely initiate the coating process and precisely terminate the coating process on individual plates delivered at irregular intervals. In the case of lithographic printing plates, the developer fluid must be applied in the correct amount uniformly distributed across the width and length of the plate, with minimal waste.

The use of a wire-wound rod in metering the developer in a lithographic plate processor is known from U.S. Pat. No. 4,737,810, which teaches the application of excess developer with the wire-wound rod serving as the means to meter off the excess into some recovery means. The rod thus serves as the means to control the volume of fluid consumed in the development process. The developer fluid is applied to the plate ahead of the wire-wound rod and it is indicated in this patent that the path between the delivery of the fluid and the metering at the wire-wound rod is sufficiently short that development does not commence within this area. However, a horizontal force is imposed by the rod on the deposited developer as a consequence of the leveling or metering effect. The excess developer removed in this area is intended to be reused.

Typical imaging methods include exposure to radiation and writing by ink jet. As is well known in the art, the imaging process renders the coating soluble in the imaged areas of a positive-working plate and renders the coating insoluble in the imaged areas of a negative-working plate. In either case, it is the coating that has been rendered soluble or the coating that has remained soluble which is removed. The particular compositions of the developer solutions for these different types of printing plates are well known. For example, many of the printing plates currently in use are positive-working plates and have coatings that contain alkali-soluble resins, specifically phenolic or acrylic resins. These coatings usually contain dissolution inhibitors that render them insoluble in the alkaline developers. The imaging process reverses this dissolution inhibition and the coating then becomes soluble in the areas subjected to the imaging radiation.

With positive-working plates, the difference between the solubility of the imaged and non-imaged areas of the coating is generally less than the difference in solubility for negative-working plates. For that reason, the development process is more critical for positive-working plates. Because the development mechanism for positive-working plates is a percolation process the present inventors believe that a quiescent film of developer solution is critical. Any relative movement between the developer and the surface of the plate must be minimized or eliminated. Furthermore, the film of developer must be uniform with no bubbles. Some aspects of these critical improvements in how the developer is applied to the plate are described and claimed in our U.S. application Ser. No. 10/446,357.

It is thus well known that after coating and drying, positive working plates have a weak, unstable developer resistance. Plate manufacturers may resort to a variety of techniques for “conditioning” the plates before shipment. The coating contains dissolution inhibitors, but all potential reaction sites are not inhibited. It is believed that during conditioning, the coordination of the inhibitor continues until it achieves a stable network. The coating thus achieves a stable level of inhibition to the developer. After imaging by the user, the solubility of the imaged regions renders those regions more susceptible to dissolving in the presence of developer than the non-imaged regions. The conditioning enhances resistance of the non-imaged areas from the dissolving effect of the developer, to a greater extent than it enhances the resistance of the imaged areas. Thus, the latitude of the plate is increased. Conditioning may be achieved by storing plates in a humid chamber or at elevated temperatures for many days after coating. Other techniques include applying another, non-imageable coating that over time causes migration of inhibiting molecules or ions into the imageable coating. U.S. Pat. Nos. 6,706,446; 6,461,795; and 6,596,457 describe examples of the significant and costly efforts that are currently proposed by others for conditioning positive working plates.

### SUMMARY OF THE INVENTION

The object of the present invention is to provide a method of developing lithographic plates so superior to conventional bath, sump or other known developing techniques that for the first time commercially acceptable image resolution can be achieved at production output rates, on unconditioned or partially conditioned positive working plates.

This objective is achieved by assuring quiescence (no relative movement) between the developer and the plate during the development period.

A feature of this quiescence is that the developer fluid is applied uniformly with self-leveling over the plate at the required thickness. This contrasts sharply with prior art arrangements where the fluid is applied to the plate some distance ahead of a device that spreads, meters, or levels the developer uniformly over the plate. A related feature of the invention is that the fluid is applied in the exact amount required to form a uniform film of the desired thickness without the need to remove and recycle excess fluid.

In a broad aspect, the present invention is directed to a process for developing an imaged lithographic plate having regions that are soluble and regions that are insoluble in a developer fluid, by applying developer fluid over the plate to dissolve the soluble regions of the plate then rinsing the plate to remove the developer and dissolved material, wherein the improvement is in applying the developer fluid by contacting the plate with a self-leveling flow of developer fluid to produce a uniform film of developer fluid on the plate and maintaining the developer fluid in contact with the plate for a period of time until the soluble regions are dissolved, without relative movement between the plate and the applied developer during the development period.

In another aspect, the present invention is directed to a process for developing an imaged positive working lithographic plate by applying an alkaline developer solution to dissolve the imaged areas of the plate and rinsing the plate to remove the developer and dissolved material, wherein the improvement is in the step of applying developer by contacting the plate with a self-leveling flow of developer and maintaining the developer in contact with the plate for a period of time until the imaged areas are dissolved, without relative movement between the plate and the applied developer during the development period.

In yet another aspect, the invention is directed to a process for developing unconditioned or a mixed sequence of conditioned and unconditioned positive working plates, comprising supporting each plate in a uniform horizontal orientation, depositing a uniform film of developer on the plate, maintaining quiescence of the film relative to the plate for a period of time sufficient to dissolve the imaged areas of the plate, and rinsing the plate to remove the developer and dissolved material.

Preferably, the step of contacting consists of depositing a thin film of developer as a continuos vertical curtain from a source of developer to the plate.

Alternatively, the step of contacting consists of depositing a multiplicity of jets of developer perpendicularly to the plate surface.

As used herein, “self-leveling” should be understood as meaning that the developer is caused to contact the coating on the plate and without outside influence, immediately form a film of uniform thickness, preferably in the range of about 2-10 mils. Also preferably, the initial contact of the developer on the plate coating is essentially perpendicular to the plate orientation, e.g., vertical to the horizontal plate.

A related object is to improve the uniformity of developed positive working lithographic plates at any given user's facility. With the present invention, high uniformity of half tone dot values can be achieved on positive plates without regard to variations in the extent of conditioning during manufacture or storage, i.e., the latitude is increased.

### BRIEF DESCRIPTION OF THE DRAWINGS

FIG. 1 is a general diagrammatic sketch of a lithographic printing plate developer system for implementing the present invention.

FIG. 2 illustrates one embodiment of the use of a wire-wound rod and fluid delivery means for applying the fluid to the surface.

FIG. 3 illustrates a second embodiment of the wire-wound rod.

FIG. 4 illustrates a further embodiment for delivering the fluid to the wire-wound rod.

FIG. 5 is a cross section of the wire-wound rod and fluid delivery tube of FIG. 4.

FIG. 6 is a general diagrammatic sketch of a first variation of a second embodiment of a lithographic printing plate developer system, for applying a uniform film of fluid to a moving flat surface in accordance with the invention.

FIG. 7 is a diagrammatic plan view of the conveyor of FIG. 6 showing the processing of two plate lines at different intervals.

FIG. 8 is a schematic plan view of a second variation of the second embodiment of a coating apparatus incorporating the invention.

FIG. 9 is a schematic plan view of a third variation of the second embodiment of a coating apparatus according to the invention.

FIGS. 10A and B are schematic representations of halftone dots on unconditioned positive working plate resulting from development according to a comparative example using conventional sump development and an example according to the invention using quiescent belt development, respectively.

### DESCRIPTION OF THE PREFERRED EMBODIMENTS

First Embodiment

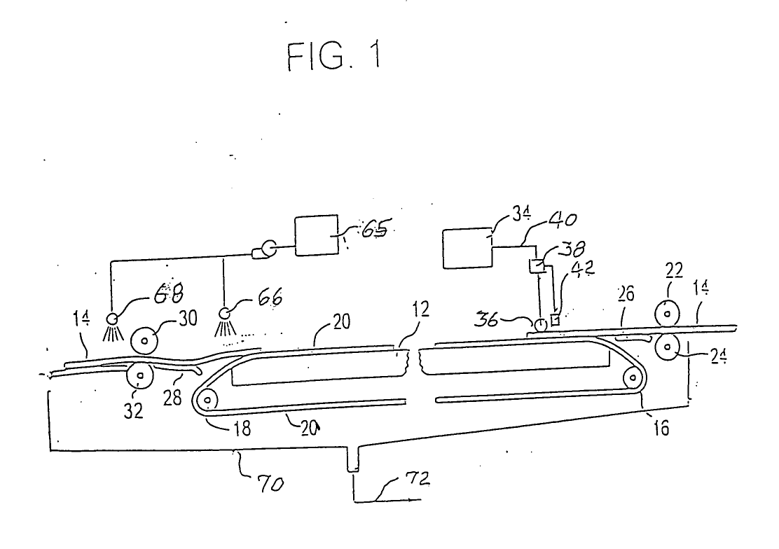

FIG. 1 is a diagrammatic drawing illustrating the general arrangement of equipment for practicing the inventive method for developing an imaged lithographic plate, preferably a lithographic printing plate. The developer apparatus comprises a substantially horizontal support structure which is preferably a platen 12 which may be any flat, horizontal surface composed of materials which will be unaffected by the particular developer solution to be used. In the context of the present invention and as used herein, the terms substantially flat and or substantially horizontal are defined as deviating from flat and/or horizontal only to the degree that the developer solution applied to the plate does not flow over or off of the surface of the plate. That is, the developer solution will remain as a film on the plate and have a thickness that produces uniform development over the entire area of the plate. The printing plate 14, which has been exposed and thus imaged, is carried across the platen 12 by means of a conveyor which comprises the conveyor drive rollers 16 and 18 and a continuous flexible conveyor belt 20. The conveyor belt 20 is composed of a material which will be unaffected by the developer solution, such as stainless steel or a polymer material. The printing plate 14 is fed by the feed rollers 22 and 24 onto the feed platform 26 which directs the printing plate onto the conveyor belt 20 for transport across the platen 12. After processing, the printing plate is guided by the discharge platform 28 into a pair of discharge rollers 30 and 32. Although the flat platen is the preferred support structure, other supports can be employed for the conveyor belt. For example, the support structure could be a series of rollers that have a small diameter and are closely spaced such that they provide adequate support to maintain a flat plate. Also, although the drawing depicts a conveyor belt for conveying the plate across the support structure, other conveying means could be employed. Merely as one example, the plate can initially be conveyed across a support structure such as a platen by the feed rollers for the plate and it can then be further conveyed the remaining distance directly by small driven rollers.

In the present invention, a wire-wound rod coating system including means for metering and feeding the developer solution to the rod is used to control the thickness and assure the uniformity of the developer solution on the plate. The developer flows as a continuos vertical curtain from the rod to the plate surface, thereby avoiding vertical impact forces of developer against plate, and due to the fluidity of the “curtain” where it contacts the plate, minimizing any incidental horizontal forces between the developer and the plate. In contrast to the known techniques where an excess of fluid is applied and subsequently metered off by the wire-wound rod, the present invention delivers precisely the required volume of developer at precisely the rate required to obtain a uniform film of developer on the plate in the amount needed to process the plate with very little excess.

The preferred means for controlling the volume of developer delivered and the rate at which it is delivered is a peristaltic pump. The delivery of the developer is commenced at the beginning of the plate and continues at the appropriate rate of flow until the end of the plate where it is stopped. The wire-wound rod in the present invention is merely a means for ensuring the uniform distribution of the developer across the surface of the plate since there is little if any excess developer to be removed. Thus all problems with developer degradation that arise from the recirculation of excess developer are eliminated.

In the context of the present invention, the term “wire-wound” includes what are termed “formed rods” or so-called Mayer rods. These formed rods are manufactured by machining a rod or tube to produce a rolled thread-like profile that duplicates the pitch and radius of the rods formed by winding wire and are to be understood to be the equivalent of rods formed by winding wire onto a core. In one embodiment, a wire-wound coating rod is fabricated using a hollow tube as the core on which the wire is wound. The developer is delivered to the interior of the tube. There are penetrations through the wall of the tube allowing the developer to flow out from the interior. There are two main alternatives for this rod embodiment. In one alternative, the wire is tightly wound around the circumference of the rod, i.e., there are no gaps between adjacent winds. In this alternative, it is necessary to provide some means for the fluid to flow through the wire. This can be accomplished by drilling holes at a series of locations between adjacent wraps of the wire. The drilling may be any means of providing holes including direct mechanical drills or the use of laser beams to remove material and form a hole. In this embodiment, the hollow tube that serves as the core of the rod may be provided with slots or holes prior to being wound with wire. The holes between the wraps of the wire are subsequently drilled at locations corresponding to the positions of the holes or slots in the tube. Alternatively, a hollow tube with no slots or holes may be wound with wire, and the subsequent drilling of the holes between the wire wraps may be done such the penetration through the hollow tube is made during this drilling process.

In the second alternative, the wire is loosely wound around the hollow tube, i.e., the helical pitch of the winding exceeds the diameter of the wire, resulting in a gap between adjacent winds. For example, if a wire with a 0.010″ (10 mils) diameter is wound on a helical pitch of 0.011″, there will be a gap of 0.001″ between adjacent wraps. The gaps allow for the liquid to flow out between the wires. The hollow tube is preferably provided with slots or holes prior to the winding, but the drilling of holes in the tube in the gaps between the wire after winding is possible.

The holes or slots provided are distributed along the length of the tube to enable the developer to be spread uniformly across the width of the plate. The tube is filled with the fluid to the level of the holes or slots. The small openings in the tube inhibit the exchange of air into the interior of the tube. This is an important advantage when using alkaline developers that are subject to degradation by atmospheric carbon dioxide.

The peristaltic pump commences operation when the leading edge of the plate is detected by a sensor. The volume of developer delivered by the peristaltic pump causes an equal volume of developer to overflow through the slots or holes out onto the wire, where it is distributed across the plate width. The pump rate is matched to the plate speed and developer quantity requirement to maintain a uniform coverage along the length of the plate. The pump stops in conjunction with the sensing of the trailing edge of the plate. In FIG. 1, this is diagrammatically illustrated by the developer supply drum 34, the wire-wound rod 36, the developer pump 38, the developer feed line 40 and the plate sensor 42 such as a photoelectric sensor.

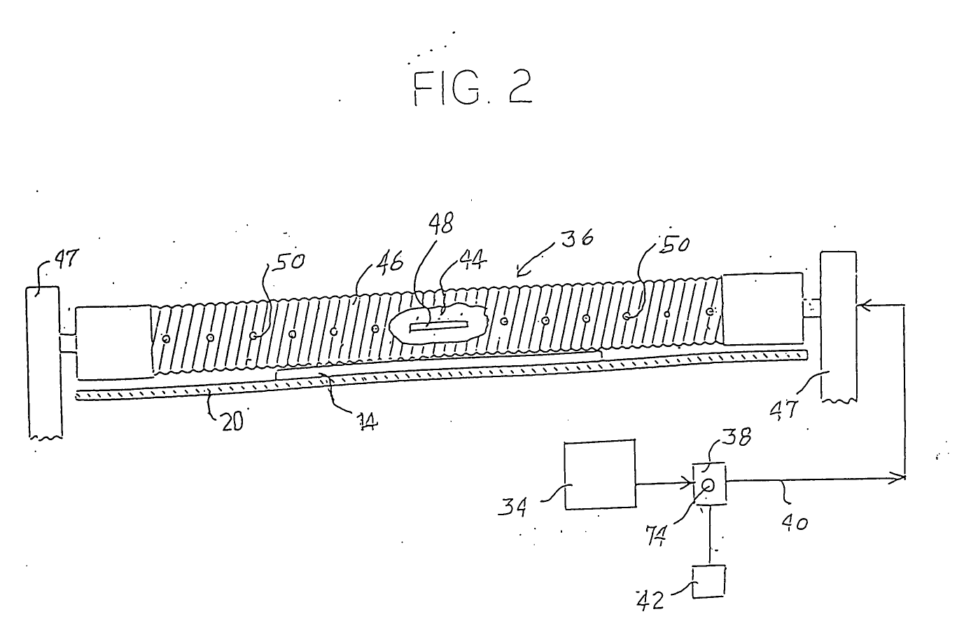

FIG. 2 shows one embodiment of a wire-wound rod and the means for metering and feeding the developer to the wire-wound rod according to the present invention. The rod itself actually comprises a hollow tube 44 with the wire 46 being spirally wound around the tube. The tube is mounted for limited vertical movement in the frame members 47 but it is mounted so as to prevent rotation. Located along one side of the tube 44 are slots 48 extending through to the inside of the tube. Although only one slot 48 is shown in FIG. 2 through the cutaway opening in the wire 46, a series of slots are lined up along the side of the tube which faces upstream with respect to the direction of travel of the plate. Merely as an example, these slots may be 1/16 inch wide by ½ inch long with 1 inch between slots. Small holes 50 are formed through the layer of wire between adjacent wraps of the wire with these holes lining up with the slots 48. The developer is fed to the inside of the tube 44 from the supply drum 34 through the flexible tube 40 which goes through the preferred peristaltic pump 38. The pump is switched on and off by the plate sensor 42. The developer exits through the slots 48 and holes 50 and runs down over the wire-wound rod onto the plate 14. In general, the thickness of the fluid applied is equal to about 9% or 10% of the diameter of the wire on the rod.

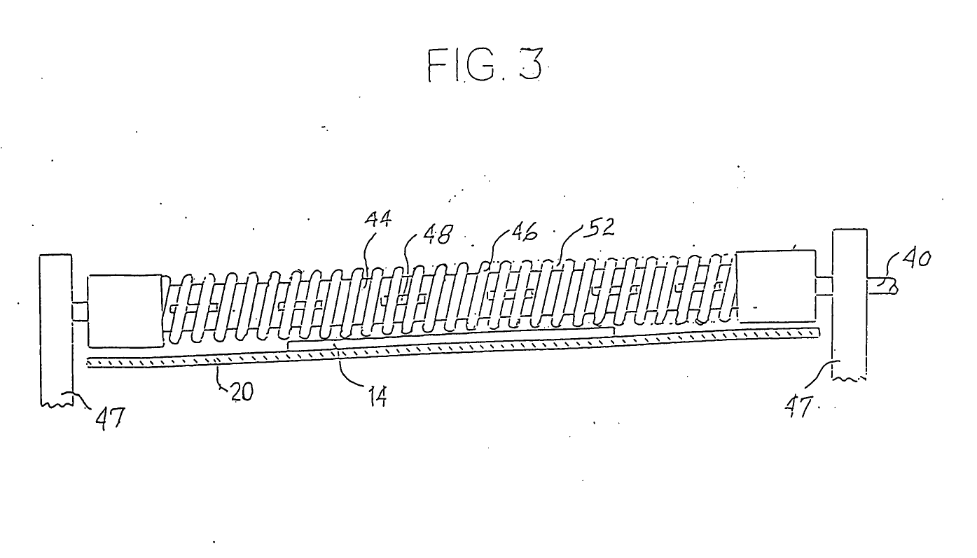

Another embodiment of the wire-wound rod of the present invention is shown in FIG. 3. The tube 44 still has the slots 48 but the spirally wound wire 46 is now loosely wound with gaps 52 between adjacent winds. These gaps permit the fluid to flow out from the slots 48 between the wires. The relative sizes of the wire and gap are distorted in this FIG. 3 for clarity from what would typically be employed. As an example, the wire might be on the order of 0.010 inches (10 mils) in diameter while the gap might be on the order of 0.001 inches wide. The gap needs to be just wide enough to permit the fluid to flow through at the necessary rate.

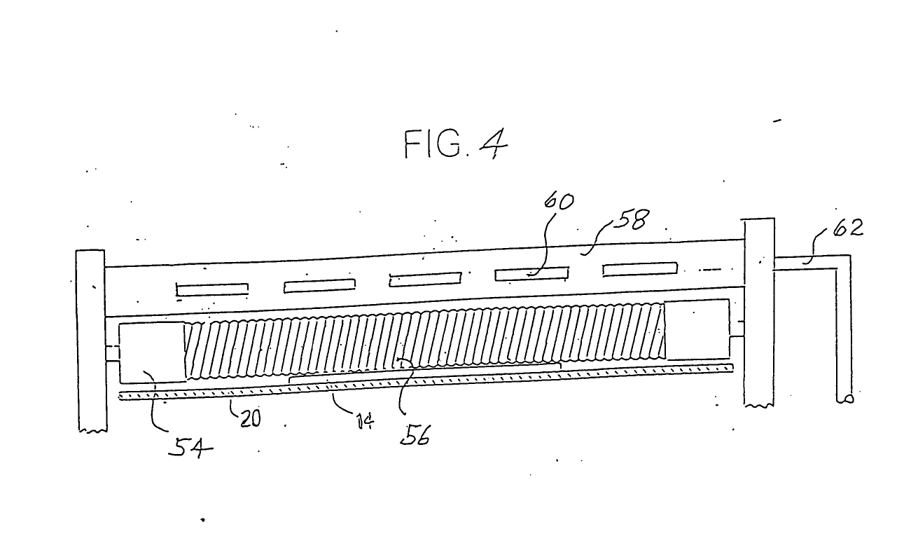

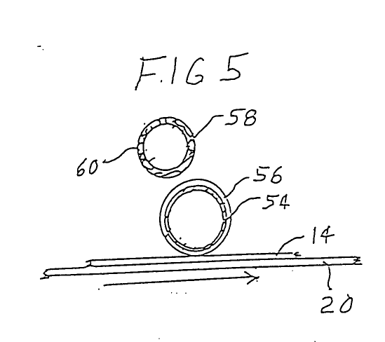

A further embodiment of the invention is shown in FIGS. 4 and 5. In this embodiment, the fluid feeding tube is separate from the rod on which the wire is wound. The rod 54 is a typical wire-wound rod containing a core, which can be solid, and wound with the wire 56. Once again, the rod 54 is mounted in the frame 47 but in this case the rod 54 can be mounted to rotate if desired. In applications where the fluid is a low viscosity fluid and the film thickness is small, it is particularly advantageous to match the circumferential surface speed of the wire-wound rod to the conveyor belt speed to reduce any tendency of the wire-wound rod to scratch the surface of the plate. In this embodiment, a fluid supply tube 58 is mounted above the rod 54. This fluid supply tube, which may be cylindrical as illustrated or any other desired cross-sectional configuration, is provided with the slots 60 similar in function to the slots 48 in FIGS. 2 and 3. The fluid is supplied to the fluid supply tube 58 through the feed line 62. The fluid supply tube is mounted above the rod 54 such that the fluid will run down the fluid supply tube and flow onto the wire 56 on the rod 54 on the upstream side of the rod 54. This is shown in FIG. 5 where the arrow 64 shows the direction of movement of the conveyor and plate and the tube 58 is located slightly upstream from the rod 54. This assures that all of the fluid fed onto the plate is subjected to the action of the wire-wound rod and not run down onto the plate on the downstream side of the rod.

The printing plate that has been coated with the developer solution continues to travel across the platen. The length and speed of travel is selected such that the developer solution will have completed the development process by the time the printing plate reaches the discharge end of the platen. A typical development time is 20 to 60 seconds. At this point, rinse water from the supply 65 is sprayed onto the plate through the spray nozzles 66 and 68. Located below the conveyor structure is a collection pan 70 which collects all of the liquid run off from the printing plate including the spent developer solution and rinse water now containing the portion of the coating which has been dissolved away. The developer solution that is rinsed from the plate is collected at 72 and sent to waste. It can be seen that there is always only fresh developer solution being applied to the plates and that there is only a small quantity of developer solution applied to each plate. It has been discovered that the consumption of developer solution can be reduced by as much as 50% when compared to a conventional printing plate development processor.

In order to properly develop an imaged plate in accordance with the present invention, it is important that the thin film of developer solution be substantially uniformly distributed over the entire upper, imaged surface of the plate as it is being conveyed across the platen. This requires that the plate on the conveyor be substantially flat and substantially horizontal or level and begins with having a substantially flat, horizontal support structure and, therefore, a substantially flat horizontal conveyor belt. Since the printing plates are very thin and flexible, surface tension is used to hold the plate firmly in position and flat on the conveyor belt. For example, this can be accomplished by providing a film of water between the plate and the conveyor belt.

The illustrated system uses simple volumetric displacement and overflow as the means for controlling the rate and volume of fluid applied to the plate. Referring back to FIGS. 1 and 2, the pump 38 commences when the sensor 42 detects the leading edge of the plate. The volume of fluid delivered by the pump is adjusted by the speed control dial, which is matched to the plate speed and quantity of fluid required to maintain a uniform coverage along the length of the plate. The volume of fluid delivered by the pump causes an equal volume of fluid to overflow through the slots or holes out onto the wire. The pump stops as a function of the sensing of the trailing end of the plate. Although other low pressure pumps could be used, the preferred pump is a peristaltic pump which offers good control of volume and flow rate. Also, there is rapid response to switching the flow on and off. The fluid only comes in contact with the tubing so chemically aggressive fluids can be accommodated. Further, the gentle pumping action reduces problems with foaming that can occur with pressurized systems. A uniform film of fluid is gently applied to the plate without bubbles to produce a quiescent film suitable for uniformly developing printing plates. Another method of feeding the fluid is by gravity flow from a raised reservoir including level control means to maintain a constant head in the reservoir. A valve in the feed line from the reservoir is triggered by the detection of the leading and trailing ends of the plate by the sensor. This embodiment is also represented in FIG. 1 when the supply drum 34 is gravity feed reservoir and the item numbered 38 is the control valve. As a further feature of the invention, the fluid is applied to the plate and coincidentally uniformly spread over the plate at the required thickness. This contrasts sharply with prior art arrangements where the fluid is applied to the plate some distance ahead of the wire-wound rod.

We have now discovered that the foregoing process is so superior to conventional bath or sump developing techniques that for the first time commercially acceptable dot values can be achieved at production output rates, on partially conditioned and even unconditioned positive working plates.

With the present invention, no active conditioning is required. More specifically, the plates may be manufactured and shipped to the customer without the risk of variable development when used at the customer location. As used hereinafter, the term “unconditioned plate” means a plate that is not in a stable state of inhibition.

The inventors believe that the quiescent film of developer percolates through the imaged areas, dissolving the imaged coating along a downward path that is perpendicular to the plate substrate. The absence of relative movement between the developer film and the plate avoids horizontal acceleration forces in the percolating developer, which would otherwise influence the developer to seep into the adjacent non-imaged regions. Furthermore, this quiescence of the developer film avoids relatively fresh developer from replenishing adjacent imaged areas where developer strength has been at least partially depleted as it percolates downward. The actual pH depletion gradient through the imaged areas more closely conforms to the ideal gradient, whereby the pH of the percolated developer at the substrate is significantly weakened. The developer at the substrate is not strong enough to attack the base of the non-imaged regions. Thus, the integrity of the non-imaged areas is maintained. This advantageous effect of quiescence may be described succinctly as producing a vertical vector of development of the imaged regions.

The following examples compare plates that are developed according to the prior art sump technique and plates that are developed according to the present invention. These examples clearly show a significant and unanticipated benefit of the invention.

### (COMPARATIVE) EXAMPLE 1

Sump Development of Unconditioned Plate

An unconditioned 830 T plate from Anocoil Corporation, Rockville, Conn. is thermally imageable and was imaged with an infrared source from a Creo/Scitex Trendsetter Imager, commercially available from Creo/Scitex, Vancouver, British Columbia, Canada. The plate was imaged at an exposure of 200 mj/cm². The image comprised halftone target areas at 175 lines per inch ruling.

The imaged plate was developed in a Glunz and Jensen Model 135 Plate Processor, commercially available from Glunz and Jensen, Elkwood, Va. The developer used was T-4 Developer commercially available from Anocoil Corporation, Rockville, Conn., which is an aqueous sodium metasilicate solution. This processor immerses the plate in a sump of developer that is recirculated during use and replenished at a rate based on usage.

### EXAMPLE 2

Inventive Belt Development of Unconditioned Plate

A processor was constructed as depicted in FIG. 1. A wire-wound coating rod was positioned at the entry end of the continuous conveyor belt. The wire-wound coating rod was constructed according to the depiction shown in FIG. 3. The core was 1¼″ stainless steel tube. Slots ½″ in length and 1/16″ in height were cut along the length of the tube at 1″ intervals. The tube was subsequently wound with 0.020″ stainless steel wire. The wire was wound at a helical pitch of 0.021″, giving a 0.001″ gap between adjacent winds on the tube. The tube was placed in the processor on the continuous conveyor belt so that the axis of the tube was perpendicular to the direction of travel of the belt and the orientation of the slots was toward the plate entry end of the processor. One end of the tube was capped and the other end was fitted with a flexible tubing connection. The wire-wound tube was connected to a variable flow peristaltic pump available from VWR International of Bridgeport, N.J.

An unconditioned 830 T plate as in Example 1 was imaged in the same manner as in the Example 1. The imaged plate was processed according to the invention using a developer comprising an aqueous sodium metasilicate solution having the following composition:

82.9% Water

13.0% Sodium metasilicate pentahydrate

1.0% Sulfetal LS

3.0% Triton H-66

0.1% Triton X-100

Sulfetal LS is a sodium lauryl sulfate surfactant available from Charkit Chemical Corporation of Darien, Conn.

Triton H-66 is an anionic surfactant available from Union Carbide Corporation of Danbury, Conn.

Triton X-100 is a nonionic surfactant available from Union Carbide Corporation of Danbury, Conn.

A summary of the measured halftone dot values is given in Table 1. The area of interest on the plates was a series of vertical targets of different halftone values. These target values going from left to right across the plate were 50%, 30%, 10%, 70%, 10%, 30% and 50%. It is clear that the Example 2 plate of the present invention has dot values that are much closer to the nominal target values. More significantly, the halftone dot values for the Example 2 plate are more consistent on the left and right sides of the plate than for Example 1. Both developing techniques yield acceptable dot values where the target is well above 50%. However, for very light halftones, i.e., 5% and 10%, the conventional sump processing completely dissolves the desired dots, whereas the inventive technique retains commercially acceptable dots. For medium light halftones, i.e., 30% and 50%, the conventional sump technique falls well below commercial acceptance. The 50% target values are 45% left and 46% right for the plate processed according to the method of present invention. By contrast, Example 1 shows a very large variation in the 50% target values; 39% left and 19% right. It is clear that the method of the present invention yields a more uniformly and acceptably processed unconditioned positive plate than the prior art method, which is typically used commercially. Practitioners in this field would not be surprised by the dot values for Comparative Example 1. These results corroborate the conventional thinking, that positive working plates must be conditioned before imaging and developing. Practitioners would, however, be quite surprised by the commercially acceptable results on unconditioned positive plates achieved with Example 2.

TABLE 1

| | | | | | | | |
|---|---|---|---|---|---|---|---|
| Halftone target | 50% | 30% | 10% | 70% | 10% | 30% | 50% |
| dot value | | | | | | | |
| Location on plate | left | left | left | center | right | right | right |
| Comp. Example 1 | 39.0% | 9.5% | 0.0% | 65.0% | 0.0% | 0.0% | 19.0% |
| measured dot value, | | | | | | | |
| fresh (not conditioned) | | | | | | | |
| Example 2 | 45.0% | 26.0% | 8.0% | 67.0% | 8.5% | 25.5% | 46.0% |
| measured dot value | | | | | | | |
| fresh (not conditioned) | | | | | | | |
| Comp. Example 3 | 47.1% | 26.7% | 9.7% | 68.8% | 112% | 28.1% | 50.0% |
| measured dot value, | | | | | | | |
| aged (conditioned) | | | | | | | |
| Example 4 | 46.7% | 26.2% | 12.5% | 71.0% | 12.2% | 29.2% | 48.3% |
| measured dot value | | | | | | | |
| aged (conditioned) | | | | | | | |

The following examples compare conditioned, imaged positive working plates that were developed in a conventional sump and identically imaged plates that were developed using the quiescent technique according to the invention.

### (COMPARATIVE) EXAMPLE 3

Sump Development of Conditioned Plate

All the conditions of Example 1 were repeated except that the plate had been conditioned by storage at elevated temperature.

### EXAMPLE 4

Belt Development of Conditioned Plate

All the conditions of Example 2 were repeated except that, as in Example 3, the plate had also been conditioned by storage at elevated temperature.

These Examples 3 and 4 show that both techniques for development of conditioned positive working plates perform satisfactorily. This confirms that the quiescent developing technique according to the invention is superior to conventional techniques not only with respect to unconditioned plates, but that it can be used for developing all kinds of plates. High uniformity of dot values can be achieved on positive plates without regard to variations in the extent of conditioning during manufacture or storage.

Second Embodiment

Other techniques for applying the developer can also achieve the quiescent film effect associated with the equipment of FIG. 1. For example, the developer can be applied with a scanning inkjet head, such as described in copending U.S. application Ser. No. 10/783,759 filed Feb. 20, 2004, the disclosure of which is hereby incorporated by reference.

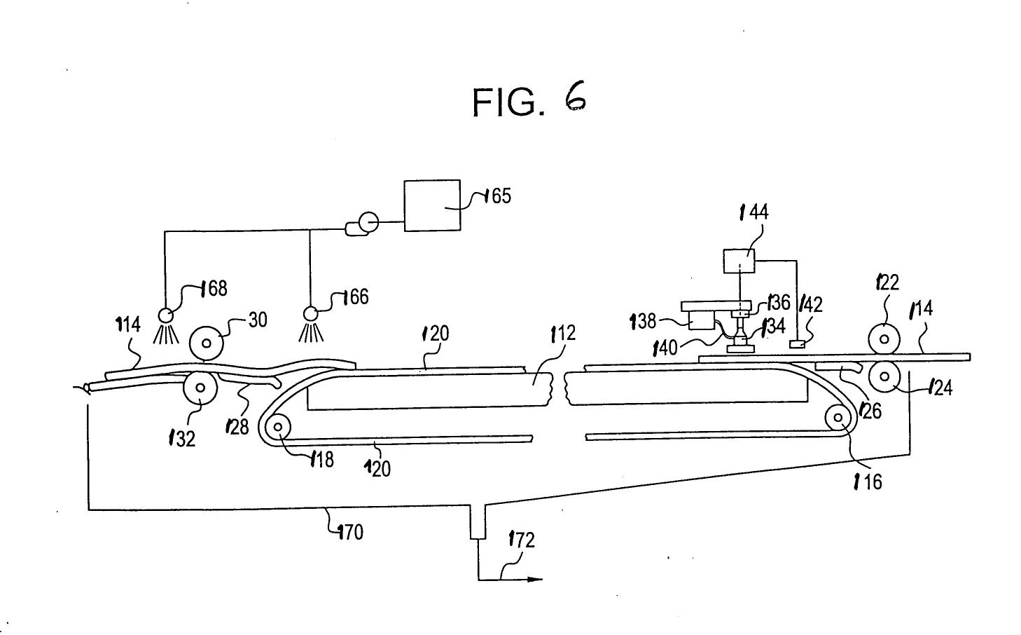

FIG. 6 illustrates the general arrangement of a second embodiment for practicing the invention illustrating the equipment and method for developing an imaged lithographic printing plate. The developer apparatus comprises a substantially horizontal support structure which is preferably a platen 112 which may be any flat, horizontal surface composed of materials which will be unaffected by the particular developer solution to be used The printing plate 114, which has been exposed and thus imaged, is carried across the platen 112 by means of a conveyor which comprises the conveyor drive rollers 116 and 118 and a continuous flexible conveyor belt 120. The conveyor belt 120 is composed of a material which will be unaffected by the developer solution, such as stainless steel or a polymer material. The printing plate 114 is fed by the feed rollers 122 and 124 onto the feed platform 126 which directs the printing plate onto the conveyor belt 120 for transport across the platen 112. After processing, the printing plate is guided by the discharge platform 128 into a pair of discharge rollers 130 and 132. Although the flat platen is the preferred support structure, other supports can be employed for the conveyor belt.

In the embodiment of FIG. 1., a jetting printhead represented at 134 is used for metering and feeding the developer solution to the plate to control the thickness and assure the uniformity of the developer solution on the plate. The jetting printhead 134 is mounted on the track 136 for movement back and forth across the plate in a raster or scan pattern as is well known in the inkjet printer technology. The developer solution in the jetting printhead 134 is replenished from the reservoir 38 through the flexible tube 40. The plate sensor 142, such as a photoelectric sensor, detects the leading and trailing ends of the plate 114. This sensor 142 is connected to the jetting printhead control unit 144 which is connected to and operates the jetting printhead. Since the conveyor speed is known, the plate sensor 142 can initiate operation of the jetting printhead at exactly the proper time to begin the coating right at the leading end of the plate. Likewise, the sensor can terminate operation when the trailing end has been coated.

In contrast to the known techniques where an excess of fluid is applied and subsequently metered off the plate, the present invention delivers precisely the required volume of developer at precisely the rate required to obtain a uniform film of developer on the plate in the amount needed to process the plate with very little excess. The delivery of the developer is commenced at the beginning of the plate and continues at the appropriate rate until the end of the plate where it is stopped. Since there is little if any excess developer applied, the problems with developer degradation that arise from the recirculation of excess developer are eliminated. The jets deposit developer substantially perpendicularly to the plate surface, with a small volume delivered to each of a multiplicity of plate areas equivalent to pixel, from a close distance. Upon contact with the plate, each pixel equivalent of projected developer quickly coalesces and joins with neighboring deposits to produces a self-leveled film of uniform thickness, without outside influence.

The printing plate that has been coated with the developer solution continues to travel across the platen. The length and speed of travel is selected such that the developer solution will have completed the development process by the time the printing plate reaches the discharge end of the platen. A typical development time is 20 to 60 seconds. At this point, rinse water from the supply 165 is sprayed onto the plate through the spray nozzles 166 and 168. Located below the conveyor structure is a collection pan 170 which collects all of the liquid run off from the printing plate including the spent developer solution and rinse water now containing the portion of the coating which has been dissolved away. The developer solution that is rinsed from the plate is collected at 172 and sent to waste. It can be seen that there is always only fresh developer solution being applied to the plates and that there is only a small quantity of developer solution applied to each plate. It has been discovered that the consumption of developer solution can be reduced by as much as 50% when compared to a conventional printing plate development processor.

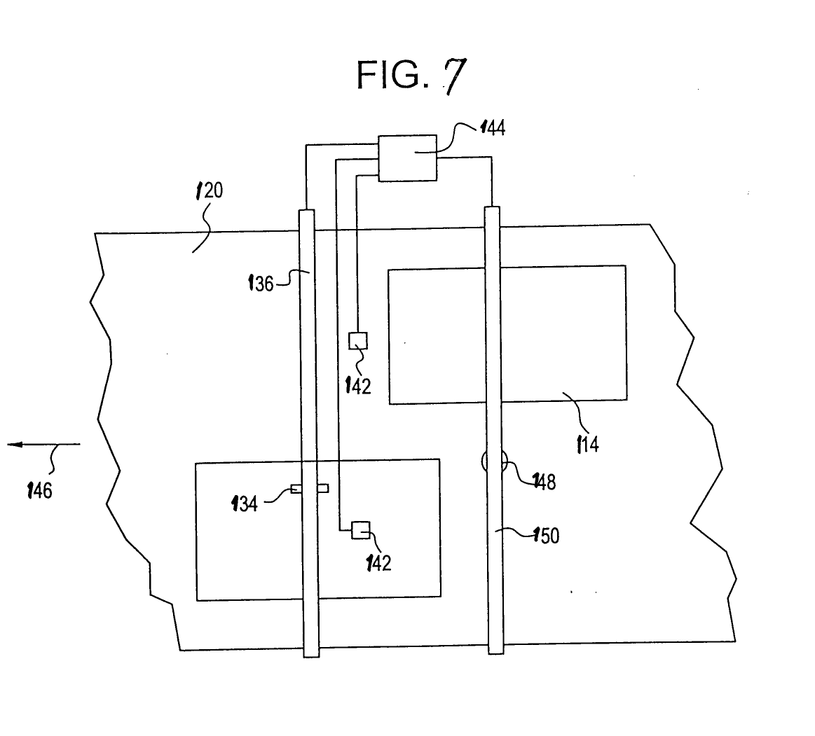

The present invention is also particularly suited to the development of lithographic printing plates in a plurality of lines or lanes in a single developing station with a single conveyor system. This aspect of the system is shown in FIG. 7, which illustrates a portion of the conveyor belt 120 moving in the direction of the arrow 146. Located on the conveyor belt 120 are two plates 114 (it could be more than two) in side-by-side relationship. The two plates can be directly side-by-side or they can be staggered as may be desired or convenient as shown in this FIG. 7. In effect, each plate has its own “lane” on the conveyor belt. Extending across the conveyor belt is the track 136 on which is mounted the jetting printhead 134 for movement back and forth across both plates. A plate sensor 142 is located in each lane for detecting the leading and trailing ends of the plates. These sensors are connected to the control unit 144 whereby the jetting printhead can be activated to move and activated to dispense the developer solution only in a lane containing a plate. In other words, the jetting printhead will dispense developer during the travel across a plate in one lane but will then shut off during the travel across the empty lane. As a further refinement, an optical scanner 148 mounted on a track 150 may be used to detect the side edges of the plates. With this scanner 148 connected to the control unit 144, the jetting printhead can be activated to dispense the developer only onto the plates. The dispensing of developer would then be deactivated between plates and past the outside edges of the plates.

A specific example of jetting printhead which could be employed in the present invention is the Spectra Nova 256/80 series of printhead from Spectra, Inc. of Lebanon, N.H. These printheads have the following characteristics:

| | |
|---|---|
| Image height | 2.8 inches |
| Number of orifices | 256 |
| Drop rate per orifice | 20,000/sec. |
| Drop volume | 75 picoliters (pl) |

For a 14-inch wide plate, the area covered in one swipe is 39.2 in². Therefore, the film thickness is 2.1 mils.

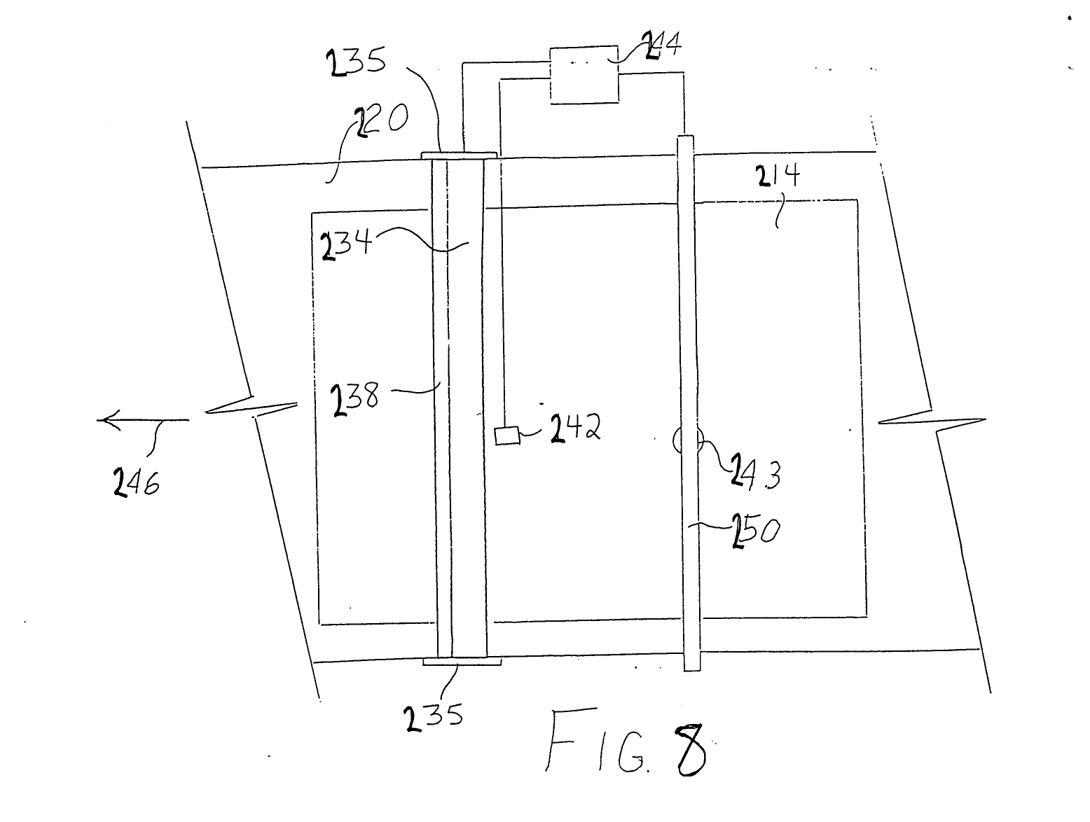

FIG. 8 schematically shows another embodiment of the invention, in which a wide jetting printhead 234 is used for metering and feeding the developer solution to the plate to control the thickness and assure the uniformity of the developer solution on the plate. In this embodiment, the jetting printhead 234 is fixed to a stationary support frame 235 on each side of the conveyor belt 220. The conveyor belt 220 is configured to move in the direction of arrow 246. The developer solution in the jetting printhead 234 is replenished from a reservoir 238 which can be formed on or mounted to the printhead 234, or can be a separate component. The printhead 234 has a length generally corresponding to the width of the conveyor 220. As an alternative, two, three, four or more printheads can be arranged side-by-side to extend across the width of the conveyor. The printhead 234 has jetting nozzles along substantially its entire length. The control means 244 provide for the ejection of developer through selected nozzles in response to input from sensors 242, 243 which detect the presence of, and the dimensions of, one or more plates 214. The use of a wide printhead 234 provides for rapid and precise jetting of developer onto the plate 214.

The first sensor 242, such as an optical sensor, detects the leading and trailing ends of the plate 214. The second sensor 243, which preferably is a scanning optical sensor mounted on a track 250, detects the sides of the one or more plates 214. The first and second sensors 242, 243 are connected to the jetting printhead control unit 244, which is connected to and operates the jetting printhead 234. Because the conveyor speed is known, the first sensor 242 can initiate operation of the jetting printhead 234 at exactly the proper time to begin the coating right at the leading end of the plate. Similarly, the first sensor 242 can terminate operation when the trailing end has been coated. With regard to the second sensor 243 it sends signals to the control unit 244 indicating which nozzles of the jetting printhead 234 are to be turned on and off. The sensor 243 prevents the jetting of developer onto the conveyer 220 between multiple plates 214 and along the sides of the conveyor 220.

In a less preferred embodiment (not shown) using a wide printhead, the continuous conveyor is replaced by a plate delivery apparatus that temporarily positions a plate in a stationary position beneath a wide jetting printhead which is configured to move along the length of the plate in a direction parallel to the direction of travel of the plate delivery apparatus in order to jet a uniform coating of developer over the plate. In this case, the wide jetting printhead moves relative to the plate in order to rapidly apply the developer to the entire plate.

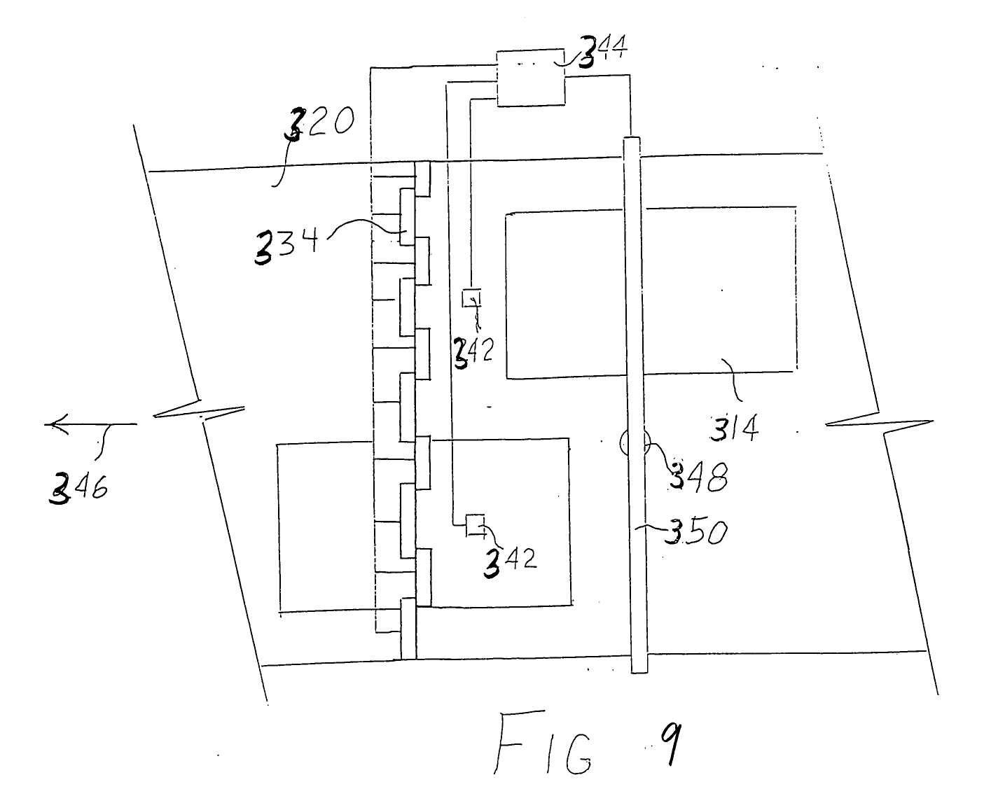

FIG. 9 schematically shows an embodiment in which a plurality of small printheads 334 are aligned in a staggered arrangement across the width of a conveyor 320 in order to quickly apply a uniform coating of developer to plates 314 which are moved by the conveyor 320 in the direction of arrow 346. The leading and trailing edges of the plates 314 are detected with sensors 342 and the sides of the plates are detected with one or more sensors 348 mounted on a support beam or track 350. A controller 344 selectively activates the printheads 334 in order to evenly coat the plates 314 with developer while minimizing overspray onto the conveyor 320. This embodiment may provide economic advantages in that a number of small, low-cost printheads 334 can be aligned to achieve a uniform spray over the plate in a time-efficient manner. The advantage of staggering the printheads 334 is to ensure that each portion of the plate can be contacted by a jetting printhead in the event that the individual printheads 334 do not have jets positioned along their outer edges. The printheads 334 may be of uniform or varying sizes.

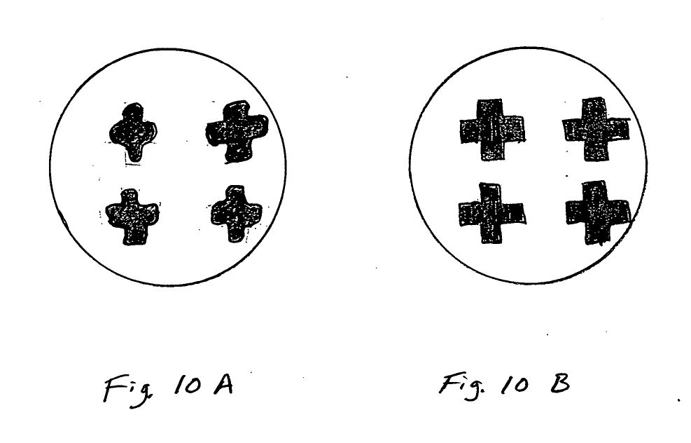

FIGS. 10A and B are schematic representations of dot structure viewed with a BETA Ultra Dottie halftone image analyzer manufactured by BETA Industries of Carlstadt, N.J., resulting from the development of Examples 1 and 2, respectively, at the 50% halftone target. The number of dots per unit area are essentially the same (due to the same imaging) but the size of each dot in Comparative Example 1 is significantly smaller than the corresponding size from inventive Example 2 (as inferred from Table 1). This is observable in that the dot boundaries (FIG. 10A) are much more rounded than exhibited by Example 2 (FIG. 10B). The dots resulting from development according to the invention retain the rectangular pixel shape of the discrete imaging exposure pattern, whereas the dots resulting from development in the sump show rounding at the corners, or dot sharpening, which is undesirable. This rounding is consistent with seepage of strong developer into the base of the non-imaged regions. The inventors believe this seepage is due in large part to the significant relative movement between the plate and the developer during processing in the sump.

1. A process for developing an imaged lithographic plate having regions that are soluble and regions that are insoluble in a developer fluid, by applying developer fluid over the entire plate to dissolve the soluble regions of the plate and rinsing the plate to remove the developer and dissolved material, wherein the improvement comprises applying the developer fluid by contacting the plate with a self-leveling flow of developer fluid to produce a uniform film of developer fluid on the plate and maintaining the developer fluid in contact with the plate for a period of time until the soluble regions are dissolved, without relative movement between the plate and the applied developer during said period.

2. The process of claim 1, wherein the plate is maintained in a stable horizontal orientation during the development period and the soluble regions are dissolved by vertical vectors of development.

3. The process of claim 1, wherein the step of contacting consists of depositing a thin film of developer as a continuous vertical curtain from a source of developer to the plate.

4. The process of claim 1, wherein the step of contacting consists of depositing a multiplicity of jets of developer perpendicularly to the plate surface.

5. A process for developing a positive working lithographic plate having an imaged coating by applying an alkaline developer solution to dissolve the soluble imaged areas of the coating and rinsing the plate to remove the developer and dissolved material, the improvement wherein the step of applying developer consists of contacting the coating with a self-leveling flow of developer and maintaining the developer in contact with the coating for a period of time until the imaged areas are dissolved without relative movement between the plate and the applied developer during said period.

6. The process of claim 5, wherein the step of contacting consists of depositing a thin film of developer as a continuous vertical curtain from a source of developer to the plate.

7. The process of claim 5, wherein the step of contacting consists of depositing a multiplicity of jets of developer perpendicularly to the plate surface.

8. The process of claim 5, wherein the plate is conveyed horizontally by a flat belt beneath a Mayer rod that deposits the developer vertically onto the plate.

9. The process of claim 5, wherein the step of applying developer forms a film of developer having a thickness in the range of 2-10 mils and the plate is conveyed throughout said period across a substantially horizontal support structure.

10. The process of claim 5, wherein the step of applying developer forms a thin film of developer and comprises:
conveying said plates across a substantially horizontal support structure;
jetting a self-leveling uniform layer of developer solution onto the imaged coating with a jetting printhead to dissolve the soluble areas of the coating and produce a spent developer solution and developed plate and;
removing said spent developer solution from said developed plate and discharging said spent developer solution to waste.

11. A process for developing a multiplicity of imaged positive working lithographic plates, comprising:
(i) sequentially supporting the plates in a uniform horizontal orientation;
(ii) depositing a film of developer on each plate;
(iii) maintaining quiescence of the film relative to the plate for a period of time sufficient to dissolve the imaged areas of the plate; and
(iv) rinsing the plate to remove the developer and dissolved material.

12. The process of claim 11, wherein at least some of said sequentially supported plates are unconditioned.

13. A process for developing a positive lithographic printing plate having an imaged coating comprising areas of coating soluble in a developer solution, said method adapted to remove said soluble coating from said plate, comprising the steps of:
conveying the plate along a path across a substantially horizontal support structure;
applying developer solution to said plate to produce a developed plate and spent developer solution;
wherein said step of applying developer solution includes:
a. providing a horizontal cylindrical hollow wire-wound tube having a plurality of apertures along the length on one side thereof across said path; and
b. feeding developer solution into said horizontal cylindrical hollow wire-wound tube and thereby overflowing said developer solution from said cylindrical hollow tube through said plurality of apertures by volumetric displacement whereby said developer solution flows down said wire-wound tube onto said imaged coating in a continuous vertical curtain that forms a self-leveling film.

14. The process of claim 13, wherein the film of developer is applied to a uniform thickness in the range of 2-10 mils.

15. The process of claim 13, comprising the step of maintaining quiescence of the film before removing said spent developer solution from said developed plate.

16. The process of claim 15, wherein said step of removing said spent developer solution comprises rinsing said developed plate with water.

17. The process of claim 13, including detecting the leading and trailing ends of said plate and controlling said feeding of developer solution in response thereto.

18. The process of claim 13, wherein said step of feeding developer solution comprises pumping said developer solution with a peristaltic pump.

19. A process for developing a lithographic printing plate having an imaged coating comprising areas of coating soluble in a developer solution, said method adapted to remove said soluble coating from said plate and comprising:
conveying an unconditioned positive working plate along a path across a substantially horizontal support structure;
applying developer solution to said plate to produce a developed plate and spent developer solution;
wherein said step of applying developer solution includes:
a. mounting a horizontal cylindrical wire-wound member across said path;
b. mounting a horizontal hollow tube having a plurality of apertures along the length on one side thereof above said wire-wound member; and
c. feeding developer solution into said tube and thereby overflowing said developer solution from said tube through said plurality of apertures by volumetric displacement and causing said developer solution to flow down said tube onto said wire-wound member and form a self-leveling film on said plate.

20. The process of claim 19, comprising the step of maintaining quiescence of the film before removing said spent developer solution from said developed plate.

21. The process of claim 20, wherein said step of removing said spent developer solution comprises rinsing said developed plate with water.

22. The process of claim 19, further including detecting the leading and trailing ends of said plate and controlling said feeding of developer solution in response thereto.

23. The process of claim 19, wherein said step of feeding developer solution comprises pumping said developer solution with a peristaltic pump.

24. A process for developing imaged positive lithographic printing plates having soluble areas of coating comprising conveying means for moving said plates across a substantially horizontal support structure, means for applying developer solution to said imaged plates whereby said soluble areas of coating are dissolved in said developer solution to produce spent developer solution and developed plates, and means for removing said spent developer solution from said developed plates wherein said method comprises:
a. printhead jetting said developer solution onto said plates to form a self-leveling film;
b. feeding said developer solution to said printhead means;
c. activating said printhead means to jet developer solution in response to the presence of a plate under said printhead means and deactivating said printhead means in response to the absence of a plate under said printhead means; and
d. maintaining quiescence of the film relative to the plate while the soluble areas of the plate are dissolved.

25. A process for developing unconditioned, positive, imaged lithographic printing plates having soluble areas of coating comprising conveying means for moving said plates across a substantially horizontal support structure and means for applying developer solution onto said plates whereby said soluble areas of coating are dissolved wherein said method comprises:
a. printhead jetting said developer solution onto said plates to form a self-leveling film;
b. feeding said developer solution to said printhead means;
c. activating said printhead means to jet developer solution in response to the presence of a plate under said printhead means and for deactivating said printhead means in response to the absence of a plate under said printhead means; and
d. maintaining quiescence of the film relative to the plate while the soluble areas of the plate are dissolved.

26. The process of claim 25, wherein the step of applying forms a film of developer having a thickness in the range of 2-10 mils and the step of maintaining quiescence includes conveying said plates across a substantially horizontal support structure.

27. The process of claim 26, wherein said jetting printhead is stationary.
